(19) United States
(12) Patent Application Publication
(10) Pub. No.: US 2005/0165496 A1
(43) Pub. Date: Jul. 28, 2005

(54) Computer-implemented methods and computer systems for scheduling the execution of an action

(76) Inventors: Frank Westendorf, Ubstadt-Weiher (DE); Vibeke Egetoft, Wiesloch (DE); Norbert Schroeder, Bergisch-Gladbach (DE)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/965,161

(22) Filed: Oct. 15, 2004

(30) Foreign Application Priority Data
Oct. 17, 2003 (EP) 03 023 436.3

(51) Int. Cl. G05B 11/01; G06F 11/00

(52) U.S. Cl. 700/23; 700/19; 700/11

(57) ABSTRACT

Computer-implemented methods and computer systems are provided for executing at least one action in response to the content of a data object describing an event or incident triggering the at least one action. As disclosed herein, the at least one action to be executed may be determined on the basis of the content of the data object and an execution plan object may be generated on the basis of the determination of the at least one action. Further, the execution plan object may include a schedule of the execution of the at least one action and the at least one action may be executed according to the execution plan object schedule.

### BACKGROUND

I. Field

The present invention generally relates to the field of data processing and to methods and systems for executing actions on the basis of the content of a data object, wherein the content of the data object may describe an event or incident triggering one or several actions. More particularly, and without limitation, the invention relates to computer systems and computer-implemented methods for executing at least one action in response to the content of a data object describing an event or incident triggering the at least one action. Embodiments of the invention further relates to computer programs and computer program products with program coding means suitable for carrying out methods consistent with the invention.

II. Background Information

There are many areas in which actions to be executed are controlled by a computer system by means of a computer-implemented method. One of these areas, e.g., is in the field of commission payments. Commission payments may include remuneration payments to employees or agents within the framework of a compensation plan. The background section and the problems in the art will now be explained with regard to the field of commission payments. However, it will be understood that the same issues can be found in other areas too, e.g., the shipment of goods, the control of a manufacturing line, etc.

Managing employee compensation plans has traditionally been done manually on spreadsheets or through in-house developed applications. For a large organization, compensation plans are typically complex and involve rewards like commissions, bonuses, splits, accelerators, draws, caps, etc. and are notoriously difficult to maintain and manage accurately. Target agreements (also called objective agreements) play an important role in modern staff management in conjunction with assessment systems. For example, target agreements may be used within the framework of a consultation, promotion or annual interview, in which a senior person works together with an employee or colleague to set qualitative and quantitative goals which will be looked at on a one-off basis or at regular intervals (generally at yearly or half-yearly intervals, but according to recent experience at more frequent intervals) to check the extent to which the goals have been achieved. In the case of performance-related pay, an incentive payment will be made depending on the targets achieved. Obviously, this principle can also be applied to agreements between a client and a contractor, e.g., with a contractor acting on the basis of a consultancy agreement or the like.

There are already computer programs in existence for the computer-aided management and calculation of commission on the basis of input target amounts. In the known computer programs, the remuneration payments to an employee or agent are effected, i.e., executed, when a commission case occurs. The occurrence of a commission case is input in an according data object which thus contains a description of the commission case. The commission case is the event or incident triggering a certain action, which in the example on hand is a remuneration payment. After valuation of the commission case on the basis of the individual target or commission agreement and the degree the agreement was fulfilled, the system then triggers the payment of the commission to the employee's or agent's account. This means that the known systems merely automatically perform the steps which had previously been done on paper. However, there exists a need for a more accurate commission payment methods and systems that can take into account various conditions and prerequisites which influence the flow of action in a commission payment system. For example, known systems cannot take into consideration that a commission payment can depend on the receipt of a payment by a third party, particularly the payment due to a contract forming the basis of the commission payment. Further, known systems do not provide for the possibility to reliably plan the flow of large amounts of commission payments to a number of payees.

### SUMMARY

It is therefore an object of the invention to provide systems and methods for executing at least one action in a more flexible and reliable manner. A further object of the invention is to provide for the possibility of generating an execution schedule for the at least one action to be executed. According to one embodiment, these objects are achieved by proposing a computer-implemented method or computer systems for executing at least one action, as disclosed herein. Computer program products and computer programs may also be implemented, consistent with the disclosed embodiments and features of the invention.

In accordance with one aspect, an execution plan object may be generated on the basis of an action to be executed, wherein the execution plan object comprises a schedule of the execution of the action, the action being executed according to the execution plan object schedule. As a result, embodiments of the invention may provide for the possibility of creating an individual execution plan, for example, on the basis of a standard execution plan, with regard to individual conditions of the event or incident triggering the action to be executed.

According to one embodiment of the invention, a computer-implemented method is provided for executing at least one action in response to the content of a data object describing an event or incident triggering the at least one action. The method determines the at least one action to be executed on the basis of the content of the data object. Then, the method generates an execution plan object on the basis of the determination of the at least one action. The execution plan object comprises a schedule of the execution of the at least one action. The at least one action may be executed according to the execution plan object schedule.

According to another embodiment of the invention, a computer system is provided for executing at least one action. The computer system may include a computing unit, a data object component for managing a set of data objects, an execution plan module for generating an execution plan object on the basis of a determination of the at least one action, and an execution module for executing the at least one action to be executed according to the execution plan object schedule. The data objects of the set of data objects may contain a description of an event or incident triggering at least one action to be executed. The execution plan object comprises a schedule of the execution of the at least one action.

Further embodiments of the invention comprise computer program products comprising a computer-readable medium. The computer-readable medium comprises instructions suitable for carrying out methods of the invention for executing, for example, at least one action in response to the content of a data object describing an event or incident triggering the at least one action. Embodiments of the invention also comprise computer programs stored on a computer-readable medium.

Further features and embodiments of the invention will become apparent from the description and the accompanying drawings.

It will be understood that the features mentioned above and those described hereinafter can be used not only in the combination specified, but also in other combinations or on their own, without departing from the scope of the present invention.

Embodiments of the invention are schematically illustrated in the drawings by way of example and further described hereinafter in detail with reference to the drawings. It is understood that the description is in no way limiting on the scope of the present invention and is merely an illustration of embodiments of the invention.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a schematic view of an exemplary computer system, according to one embodiment of the invention; and

FIG. 2 is a schematic block diagram representation of a system for implementing embodiments of the present invention.

### DETAILED DESCRIPTION

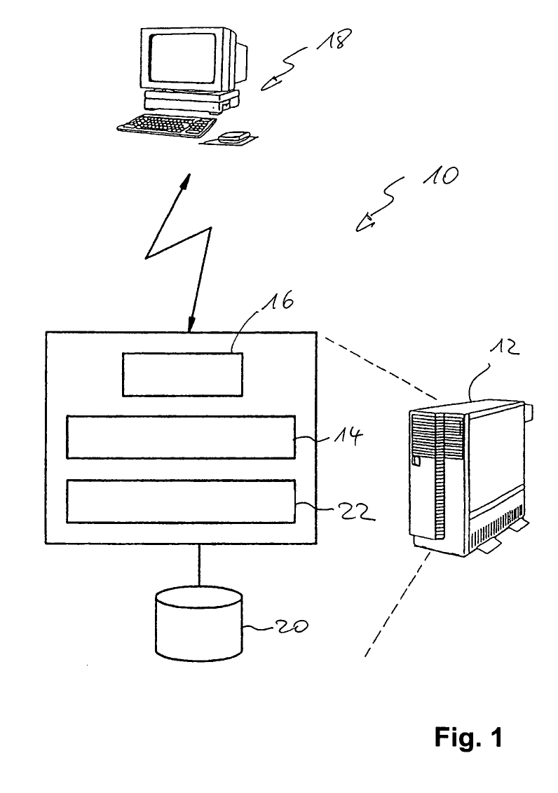

FIG. 1 shows a schematic block diagram representation of a scheduling system 10, according to one embodiment of the present invention. The computer scheduling system 10 may be implemented for executing at least one action. As shown in the example of FIG. 1, computer scheduling system 10 comprises a computing unit 12 with a central processing unit CPU, a network connection 16 for connection with at least one input/output means 18 and at least one database means or data object component 20 containing data objects describing an event or incident triggering at least one action to be executed. The computer scheduling system may further comprise an execution plan module 22 for generating an execution plan object on the basis of a determination of the at least one action, as well as an execution module 14 for executing the at least one action to be executed according to the execution plan object module. According to one embodiment, the execution module 14 comprises an interface (not shown in detail) with another software solution or another computing system for transmitting any data needed for the execution of the action.

In the embodiments described hereinafter, the action to be executed is a remuneration payment in result of a commission case, with the data objects being a commission contract between two parties containing an individual payment plan agreement. However, it will be appreciated by those skilled in the art that the principles of the invention are not limited to the embodiments described herein, but rather do apply to various fields in business, commerce, industry, manufacture, etc. in which an individual action is triggered by an event (such as a payment, delivery, contract fulfillment, or even accident) and a time schedule for executing such action is created.

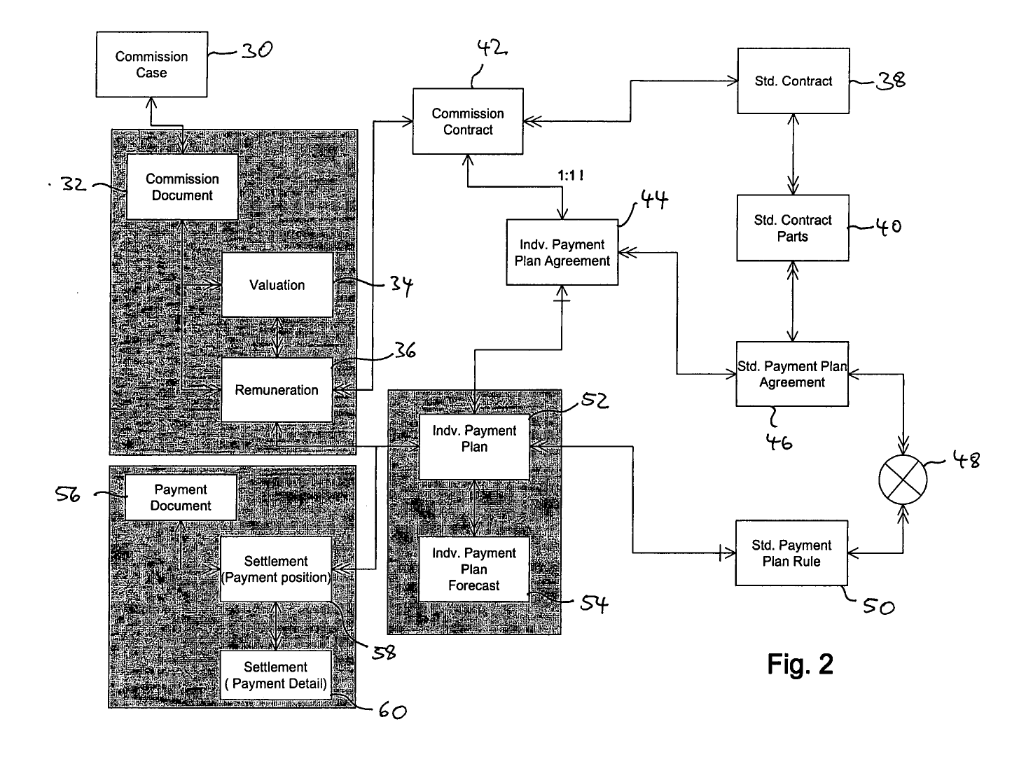

With reference to FIG. 2, a schematic block diagram is provided for illustrating embodiments of invention in the field of commission payment. However, as already pointed out above, the principles of the invention apply to other fields in which an action to be taken is triggered by an incident. In FIG. 2, the incident is a so-called commission case 30, and the action that is triggered by the commission case is the settlement 60 of a remuneration 36 of a given sum according to, for example, a commission contract 42.

Traditionally, in the event of a commission case, a valuation is performed leading to the calculation of a remuneration with remuneration details, and in a next step the remuneration is then settled.

According to one embodiment of the invention, the direct relation between calculation of a remuneration and its settlement may be uncoupled and the creation of an execution plan with execution plan details can be added. In FIG. 2, the execution plan is, for example, a payment plan 52.

Thus, on the basis of the information given by valuation, remuneration and remuneration details a payment plan is created containing additional information as to the payment positions (e.g., forecast and settlement). Then, the payment plan document with payment plan settlement detail positions is posted separately from the original settlement process.

Referring to FIG. 2 again, the arrows between the block diagram boxes with a first single arrowhead and a second double arrowhead are 1:n arrows, i.e., a single arrowhead stands for an unequivocal unambiguous relation, and a double arrowhead stands for an equivocal ambiguous relation. For example, according to the embodiment of FIG. 2, the standard contract 38 is the basis for a plurality of commission contracts 42 (double arrowhead pointing from 38 to 42), but each of the plurality of commission contracts is based on one and only one standard contract (single arrowhead pointing from 42 to 38). According to one embodiment, there may be a 1:n relation between a standard contract and a commission contract. The same applies to the relation between standard contract 38 and standard contract parts 40 or the standard payment plan agreement 46 and the individual payment plan agreement 44.

As can be seen from the FIG. 2, an individual commission contract 42 is concluded on the basis of a standard contract 38 consisting of a variety of standard contract parts 40. Additionally, an individual payment plan agreement 44 is concluded on the basis of the standard payment plan agreement 46 which again consists of a variety of standard payment plan agreements. In the embodiment of FIG. 2, a 1:1 arrow is linking the commission contract 42 and the individual payment plan agreement 44, which means that there is exactly one individual payment plan agreement per given commission contract. The individual payment plan agreement 44 is an individualization of the standard payment plan agreement 46 and is created as part of the commission contract.

Consistent with one embodiment, the payment plan agreement may contain all the payment plan rules which are valid for an according contract, as well as the rules for finding the correct payment plan rule for a given claim.

In a first step, the standard payment plan rule 50 may be created and connected to logical services. Then a determination module is defined, depicted with 48 in FIG. 2. In a third step, the standard payment plan agreement 46 is defined and connected with the determination module 48, which may allow for a flexible determination of links between the payment plan agreement and payment plan rule. Finally, the payment plan agreement is included into the standard contract 38.

Consistent with one embodiment, an individual payment plan 52 may be created. The individual payment plan 52 can be, but does not have to be (as it is indicated by the cross line just before the single arrowhead), created on the basis of the individual payment plan agreement 44. Further, it can but does not have to be created on the basis of a standard payment plan rule 50, which for example manages the period of payments, the maturities of payments and/or the net payment. The determination of any rule takes place with so-called logical services. Particularly, the standard payment plan rule controls the terms for payment(s), the period of payment (start, end), the distribution (partitioning) of the amount to be paid, the discounting in response to the way the amount is paid, and the reclaiming of payments effected in case of changes in the amount to be paid. All of this may be defined in the standard payment plan rule as logical services.

In one embodiment, the individual payment plan 52 describes how the payment amount is divided within the given period and is created additionally to the payment document 58, as will be described in more detail below. On the basis of the individual payment plan 52, one or more individual payment plan forecasts 54 can be created which describe the detailed given payment course.

In the event of a commission case 30, a commission document 32 is created with one or more valuations 34 and one or more remunerations 36, wherein there is a 1:n link between the valuations and the remunerations so that there can be more than one remunerations per valuation or, in other words, each valuation can lead to several remunerations taking into consideration the content of the individual payment plan 52.

On the basis of the commission document 32 and the individual payment plan 52, a payment document 56 for the given commission case 30 is created. The payment document 56 contains one or more settlement payment position 58 with one or more settlement payment detail 60. An interface (not shown) links the payment document 56, and preferably the settlement payment detail 60 of the payment document 56 with an accounting or payroll accounting software in order to effect automated payments.

According to one embodiment of the invention, a separate execution plan object (e.g., payment document) is created on the basis of a given incident (e.g., commission case) and the basis of the content of a data object (e.g., individual payment plan). The data object may contain a concrete plan for execution of an action built upon standard rules.

Advantageously, the execution of the action to be taken (e.g., remuneration payment) can be adapted to various needs and/or conditions. For example, in large companies or concerns remuneration payments to be effected can amount to a considerable sum. However, on the other side turnover from contracts which form the basis for the remuneration payments can sometimes be expected after a longer period of time only. In the past, this could lead to unpleasant situations in which a company had to pay a considerable amount of remuneration payments without having received any payments itself. With embodiments of the invention, remuneration payments schedules can be created automatically on the basis of the individual payment plan which consider such unpleasant situations. For example, a remuneration payment schedule could be set up to effect a first installment immediately and further installments at a later stage, e.g., after receipt of payments.

Thus, embodiments of the invention may allow for an individualized handling of actions to be executed. For example, the rule realized in the payment plan can be changed or adapted at any stage by changing rules contained in the standard payment plan rule, which in turn affects the number of individual payment plans resulting in a flexible handling of an action schedule not possible hitherto.

In general, there is no fixed assignment of payment plan rules to standard contracts. Instead, according to one embodiment, the standard payment plan agreement may include a type of feature combination by which a finding process can be triggered in order to assign payment plan rules to the individual commission contract. When no individualization is performed, no payment plan agreement exists. That means that a standard payment plan agreement is not taken over by default.

The payment plan rules can be ordered within a certain hierarchy which can be individually determined. Furthermore, each rule may be assigned a validity period which can be determined by a user. According to one embodiment, if any one of those parameters of individualization is changed by a user, a warning signal is given if the changing influences actual payment plans which are not completely transformed into payments yet.

In an alternative embodiment, payment plan rules are assigned to the standard payment plan agreement. Those rules are displayed and available when a user intends to create or change payment plan agreements of a commission contract.

According to another embodiment, in order to keep payment under control, there is the possibility to display only those payment plans of a commission contract, for example, which have not been fulfilled yet.

According to yet another embodiment, within the creation of a payment plan, there are different objects and certain actions that cause commission payment. These can be new investment, adjustment/correction, reduction/rise or cancellation/reactivation. New investment is defined within the application on hand as the transfer of an action to a new object. Adjustment means that within an actual commission case the relevant commission sum is adjusted. Reduction or rise can be triggered by an additional action as a further part of the whole object, so that the commission relevant sum is reduced or increased. Cancellation is the withdrawal of a commission case which has been recognized to be incorrect. Reactivation is the withdrawal of a cancellation.

In general, a payment plan may comprise a header and one or more positions. For the treatment concerning the duration of a payment plan, there may be metastructures within the header and the different positions. In general, the creation of payment plans may be implemented as a logical service. This is consistent with the already implemented entitlement plan. The creation of a payment plan requires parameters influencing the scheduling procedure. This could be, for example, a specification of a settlement horizon and periodicity.

With market requirements growing, the enhancement of existing payment scheduling procedures is important. In the meantime, there is often the case that customers who intend to pay commission and/or bonus entitlements in one or more payment slices in the future and not at the posting date, need an enhanced payment scheduling procedure or payment plan. The following example represents a basic example which clarifies the necessity and the potential advantages of the present invention.

An insurance agent sells a customer, namely a policyholder, an insurance policy with the duration from 1 Jan. 2003 until 1 Jan. 2013, for example. The annual premium is the basis for the entitlement for the acquisition commission as well as the follow up commission. Based on this example, the agent receives acquisition commission in the first year, and follow up commission in the following years which depends on the product. Due date of the premium is 01 January. When the agent has sold an insurance policy to the policyholder, he has normally earned an entitlement to the acquisition commission that is due immediately in most cases. In addition, he is also normally entitled to receive follow up commission for some periods. In view of this commission, two possibilities are conceivable. A policy system can send a separate trigger for the follow up commission. In this case the commission case has to determine/calculate the entitlement of follow up commission only for the actual period which is due immediately. On the other hand, a commission system should determine the complete entitlement for follow up commission based on the received object information, as for example insurance contract duration. If there is a part or full termination within the duration, a further notice is sent that indicates further commission is not required. In this case, the commission case should use a flexible scheduling functionality as is provided by the present invention.

The scheduling functionality can be used for policies with fixed validity period. This means that the scheduler needs a start date and an end date to schedule the entitlement calculated in accordance with the scheduling rules within the mentioned period. If new or changed entitlements are to be calculated and scheduled, than a new commission case is used. If policies have no fixed end date, then, for example, a renewal commission is calculated for each period separately, triggered by a separate commission case.

It is possible that all payments to be made in the future are created at the time the remuneration is created. A settlement process picks up installments according to the due dates of each single payment item. One of the possible consequences can be a cancellation of unused future payment in terms of changes to remuneration. Moreover, there is probably a higher data volume caused by changes. Payment control is only given at the time of remuneration. During a payment period rule changes are only hardly possible. Bulk changes can only be made on commission case level. This can have side effects on participating intermediaries. With help of the present invention a split has been made between the creation of the forecast, that means the planned, scheduled payment positions, and the creation of the payment position which corresponds to the due date document. The forecast is created at the remuneration time, in other words at the time when the commission case is processed. The payment installments, however, that means the settlement documents, are created at the due date by a separate functionality. By this concept the above mentioned influences can be avoided, because in this solution the forecast positions could be changed and deleted until the time that the due date documents have been created based on the forecast position.

In general, payments are corrected and the new remuneration amount is rescheduled if the reference remuneration is corrected, for example, because of liability. Actually, the payments will be scheduled based on the due amount calculated. Existing installments will remain and will be corrected by additional negative installments. Therefore, the valid settlement position will refer to invalid remuneration position. Furthermore, balance is available when reading the complete history.

Therefore, the payment plan rule has the function to plan or schedule payments based on the remuneration amount. For this a new functionality, namely a logical service, is implemented. This will read the settlement position of the corrected remuneration position and create one position to offset already paid amounts. Unpaid positions will be cancelled. In some cases the correction concerns only the future commission payment and already paid commissions should remain unaffected. Therefore, a functionality as for example a logical service that describes how corrections are to be performed can now be implemented. According to one embodiment, this depends on global settings. A possible global setting comprises, for example, a correction from the beginning. Another global setting comprises a correction from the next possible payment day.

It is known that the settlement positions, that means the due date documents, are created at the time of remuneration. According to one embodiment of the invention, settlement positions, that means the due date documents, are created against the background of a periodic process. This process creates new documents with settlement positions. During the commission case the remuneration payments are determined. Based on the entitlement calculated and the plan rules it is recommended to determine detailed forecast positions. To keep the data volume low in view of the due date documents, it is possible to summarize all positions in one position. In this case, necessary information is kept in the detail positions so it is still possible to correct a position.

It is possible that on the due date the amounts due will be transferred by the settlement run to the disbursement system without waiting for an external trigger. On the other hand it is possible that the amounts due will be transferred to the disbursement system if an external system transmits a trigger that the premium has been paid by the policyholder. Thus, the paid premium corresponds to a predefined fulfillment level causing a specific action, namely the transfer of the amount due to the disbursement system, to be executed according to a predefined execution plan object schedule. It is possible to provide a further component or functionality, respectively, which manages and regularizes the scheduling in case of the presence of other than time restricted conditions.

Payment scheduling or payment planning according to one embodiment of the present invention is used to synchronize premium income of recurring premium business with commission payments. Furthermore, it is possible with help of the payment plan to control commission payment from a risk management perspective. Therefore, payment plan rules are very much based on product-specific characteristic like premium payment frequency as for example monthly, quarterly, and are separated from the classification of the remuneration type.

Conventionally, payment plan rules are only be assigned to remuneration type and are therefore treated as an integrated part of the remuneration.

Through embodiments of the present invention, it is possible to use different plan rules for the same remuneration type. According to one embodiment, the determination of which plan rules should be used for the remuneration calculated is performed during the commission case via determination rules.

Prior to the present invention, it was not possible to influence the scheduling or plan rules out of the master data. Therefore, it was not possible to act in a quick way on requirements of the daily business.

Through embodiments of the present invention, a commission contract has the possibility to maintain payment plan agreements that have been individually adjusted.

According to one embodiment, a change of a policy can have, for example, one of the following three results in a valuation process. It is possible that the valuation is increased triggered by premium increase or duration extension. The valuation can decrease triggered by premium decrease or duration decrease. Finally, it is possible that the valuation is unchanged, as of for example in case of a change of payment frequency. All three described situations can influence the installment plans. If the result of the valuation process is that valuation amount is increased or decreased, than a new remuneration entitlement rises.

Normally, it is necessary to synchronize premium income of recurring premium business on the one hand and the commission payment on the other. One possibility is to influence the payment plan rules and the master data via the payment plan agreements. If an insurance product, as for example a life insurance allows the policyholder to choose between yearly, quarterly, monthly payments and the policyholder changes the payment frequency during the duration of the insurance policy from yearly to quarterly, than the payment frequency of the follow up commission is normally also influenced. With regard to a change of the payment frequency, a new commission case with this information is transmitted. It is possible that the change of the payment frequency does not change the total renewal entitlement, but nevertheless this activates a rescheduling of the renewal entitlement. The change of payment plan agreements has influence on the creation of installment plans for all future acquired entitlements.

Other embodiments of the invention will be apparent to those skilled in the art from consideration of the specification and practice of the embodiments of the invention disclosed herein. It is intended, therefore, that the specification and examples be considered as exemplary only, with a true scope and spirit of the invention being indicated by the following claims.

1. A computer-implemented method for executing at least one action in response to the content of a data object describing an event or incident triggering the at least one action, the method comprising:
determining the at least one action to be executed on the basis of the content of the data object; and
generating an execution plan object on the basis of the determination of the at least one action, the execution plan object comprising a schedule of the execution of the at least one action and the at least one action being executed according to the execution plan object schedule.

2. A method according to claim 1, further comprising creating an execution document on the basis of the execution plan object, the execution document comprising execution step instructions.

3. A method according to claim 1, wherein the execution plan object is generated on the basis of a standard execution plan rule.

4. A method according to claim 1, wherein the incident is a commission case and wherein the action to be executed is a remuneration payment, the remuneration payment being effected on the basis of an individual payment plan.

5. A method according to claim 2, wherein the incident is a commission case and wherein the action to be executed is a remuneration payment, the remuneration payment being effected on the basis of an individual payment plan.

6. A method according to claim 3, wherein the incident is a commission case and wherein the action to be executed is a remuneration payment, the remuneration payment being effected on the basis of an individual payment plan.

7. A computer system for executing at least one action, comprising:
a computing unit;
a data object component for managing a set of data objects, the data objects of the set of data objects containing a description of an event or incident triggering at least one action to be executed;
an execution plan module for generating an execution plan object on the basis of a determination of the at least one action, the execution plan object comprising a schedule of the execution of the at least one action; and
an execution module for executing the at least one action to be executed according to the execution plan object schedule.

8. A computer program product comprising a computer-readable medium, the computer-readable medium comprising instructions suitable for carrying out a method for executing at least one action in response to the content of a data object describing an event or incident triggering the at least one action, the method comprising:
determining the at least one action to be executed on the basis of the content of the data object; and
generating an execution plan object on the basis of the determination of the at least one action, the execution plan object comprising a schedule of the execution of the at least one action and the at least one action being executed according to the execution plan object schedule.

9. A computer program product according to claim 8, the method further comprising creating an execution document on the basis of the execution plan object, the execution document comprising execution step instructions.

10. A computer program product according to claim 8, wherein the execution plan object is generated on the basis of a standard execution plan rule.

11. A computer program product according to claim 8, wherein the incident is a commission case and wherein the action to be executed is a remuneration payment, the remuneration payment being effected on the basis of an individual payment plan.

12. A computer system for executing at least one action in response to the content of a data object describing an event or incident triggering the at least one action, the system comprising:
means for determining the at least one action to be executed on the basis of the content of the data object; and
means for generating an execution plan object on the basis of the determination of the at least one action, the execution plan object comprising a schedule of the execution of the at least one action and the at least one action being executed according to the execution plan object schedule.

13. A computer system according to claim 12, further comprising means for creating an execution document on the basis of the execution plan object, the execution document comprising execution step instructions.

14. A computer system according to claim 12 wherein the means for generating an execution plan object generates an execution plan object on the basis of a standard execution plan rule.

15. A computer system according to claim 12, wherein the incident is a commission case and wherein the action to be executed is a remuneration payment, the remuneration payment being effected on the basis of an individual payment plan.
